(19) United States
(12) Patent Application Publication
(10) Pub. No.: US 2020/0189222 A1
(43) Pub. Date: Jun. 18, 2020

(54) AEROSOL RECYCLING PROCESS AND SYSTEM

(71) Applicant: US ECOLOGY IDAHO, INC., Boise, ID (US)

(72) Inventors: MARK JOHN, BOISE, ID (US); TOM CASWELL, BOISE, ID (US)

(21) Appl. No.: 16/556,038

(22) Filed: Aug. 29, 2019

Related U.S. Application Data
(60) Provisional application No. 62/724,510, filed on Aug. 29, 2018.

(51) Int. Cl. B30B 9/32; B09B 3/00; B30B 15/08

(52) U.S. Cl. CPC B30B 9/321; B09B 2220/02; B30B 15/08; B09B 3/0058

(57) ABSTRACT

A process for recycling aerosol cans. The process includes the steps of draining the materials of the aerosol cans, collecting the materials of the aerosol cans, and refining the contents of the aerosol cans into original products that are available for resale. The step of draining the materials of aerosol cans is done by crushing the aerosol cans in an inert atmosphere and creating a metal brick from the aerosol cans. The materials are then drained into separator tanks where they can be separated and refined for resale.

### PRIORITY/CROSS-REFERENCE TO RELATED APPLICATIONS

This application claims the benefit of U.S. Provisional Patent Application No. 62/724,510, filed Aug. 29, 2018, the contents of which are hereby incorporated by reference.

### TECHNICAL FIELD

The presently disclosed technology relates generally to a method for recycling, specifically recycling aerosol cans while collecting components and contents that can be recycled.

### BACKGROUND OF THE INVENTION

By design, aerosols must remain effective at discharging a product until the product is fully used. By the design of aerosols to remain effective as dispersants of sprays until the liquids are fully consumed, the aerosols remain pressurized with the propellants when they are “empty”. Therefore, when the container is “empty” with respect to the product, it retains some propellant. Management options of “empty” aerosol units can range from traditional recycling options to direct landfill disposal of intact units. It is common for the residual propellant value to be lost when disposed.

Existing aerosol processing technologies recycle the metal components associated with the cans. Puncturing aerosol cans to remove content is a common practice in aerosol “recycling.” When contents are removed, the metal components can be recycled. Mixed liquids, typically a waste regulated under the Resource Conservation and Recovery Act (RCRA), are often blended into secondary fuels. Waste propellants, mostly comprised of propane, butanes DME, and refrigerants 152a and 134a. The waste propellants are managed using emission control devices, as secondary fuel in a permitted boilers and/or kilns, or consumed using flairs. Options for managing waste derived from existing aerosol recycling technologies are limited and can be costly.

It is apparent that a need exists for an aerosol recycling technology that provides better value from retrieved propellants.

### BRIEF DESCRIPTION OF THE DRAWINGS

FIG. 1 discloses an embodiment of the process for recycling aerosol cans.

FIG. 2 discloses a flow chart depicting a preferred embodiment of the process for recycling aerosol cans.

FIG. 3 discloses a flow chart depicting a preferred embodiment of the process for recycling aerosol cans.

FIG. 4 discloses a flow chart depicting a preferred embodiment of the process for recycling aerosol cans.

### SUMMARY OF THE INVENTION

The purpose of the summary is to enable the public, and especially the scientists, engineers, and practitioners in the art who are not familiar with patent or legal terms or phraseology, to determine quickly from a cursory inspection, the nature and essence of the technical disclosure of the application. The summary is neither intended to define the inventive concept(s) of the application, which is measured by the claims, nor is it intended to be limiting as to the scope of the inventive concept(s) in any way.

The present invention is directed toward filling the need for recycling aerosol cans by collecting, refining, and conditioning the propellants into a clean, dry product that can replace virgin product sold in commerce. This invention replaces a recycling option that inherently generates significant volumes of RCRA Waste, requiring costly disposal, with a technology that produces valuable product. It is effective not only for empty/discarded aerosols, but applies to off spec and damaged aerosol units that still contain all or most of the original volume.

What is disclosed herein is a method for recycling aerosol cans while collecting the components and contents of the aerosol cans that can be recycled. The present invention has a unique method and equipment to remove contents from aerosol cans. The propellant from aerosol cans are collected and refined into marketable products that can be sold, for example, in virgin product markets. The metal from the cans are crushed into bricks and distributed for metal recycling.

The method includes the steps of emptying a batch of aerosol cans, collecting the contents of the cans, collecting the metal from the cans for recycling, and a process that includes freezing, boiling, and condensing the contents of the cans in order to separate the different gasses to be reused and sold in virgin markets.

Preferably the method of emptying the batch of aerosol cans includes the step of crushing the aerosol cans. An inert atmosphere is maintained during crushing cycles to eliminate the hazards associated with managing flammable liquids and gasses. Also, the aerosol process is conducted under vacuum to ensure propellants and vapors are retained. The processing unit maximizes retention of valuable gasses, and reduces the possibility of emissions.

The cans are crushed to remove contents and pressed into blocks. The metal blocks have a resident time within the unit designed to allow complete drainage. The resident time is preferably approximately 45 minutes. The crushing unit extrudes densely packed metal blocks, which can be efficiently handled, transported, and recycled.

The present process is unique in that propellants are actively collected for additional processing. Siloxanes and water contaminants are removed and gasses (e.g., Propane, LPG) are separated into pure, marketable products. By design, propellants discharged from aerosol units carry desired chemicals/products out of the can. When discharged as designed, it is favorable for products to be present in the propellant. However, when recovering propellants for reuse, the product dispensed becomes a contaminant. The present invention combines a technically sophisticated can processing technology, with propellant gas collection and conditioning technology to produce a clean, dry product that is marketable as a replacement for virgin products.

The present process applies a sorting phase prior to processing. Sorting allows for a “batch” approach which results in the production of desired products.

What is disclosed includes a process to separate various components, including propellants, from waste aerosol cans further involving removing of deleterious constituents. In a preferred embodiment deleterious components are removed through one or more processes in which pressurized vapors contact cold surfaces, condensing higher dew point vapors, selectively freezing higher freezing condensates, entrapping materials soluble in the frozen condensates and removing the condensates and the dissolved materials by cyclically isolating the process vent, warming the mass, and draining the condensate, soluble contaminates, and flashing low boiling point vapors as an alternate stream from the higher vapor pressure/lower boiling constituents which remained above their dew point. The process stream may remain vaporous or as a draining condensate at the temperature and pressure of the gas cleaning step.

The gas cleaning step can also be inverted with the deleterious constituents passing over the cold surfaces with the process materials accumulating as either a frozen mass or as a liquid condensate. The three-phase separation can allow a vaporous phase to pass over the cold surfaces, a liquid condensate phase is drained over the frozen mass. Cyclically the process flow is interrupted and the mass warmed and drained separately from the liquid condensate. In this case the product or products can be any one or even two of the three phases and the removed contaminant/contaminants of either of the other phases.

Still other features and advantages of the claimed invention will become readily apparent to those skilled in this art from the following detailed description describing preferred embodiments of the invention, simply by way of illustration of the best mode contemplated by carrying out the invention. As will be realized, the invention is capable of modification in various obvious respects all without departing from the invention. Accordingly, the description of the preferred embodiments is to be regarded as illustrative in nature, and not as restrictive in nature.

### DETAILED DESCRIPTION OF THE PREFERRED EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

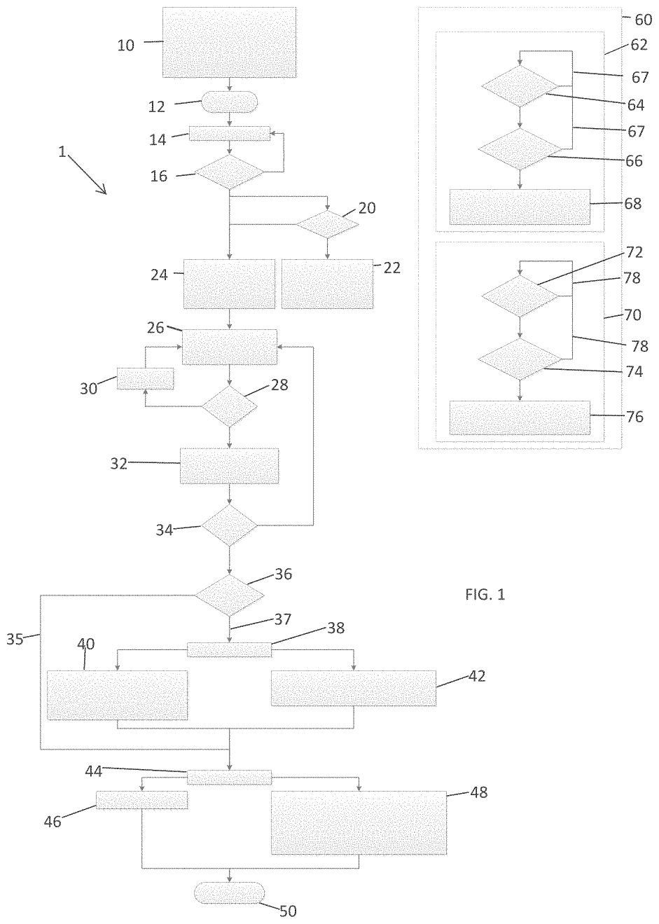

Disclosed in FIGS. 1-3 are a preferred embodiment of the process for recycling aerosol cans. In a preferred embodiment depicted in FIG. 1, the aerosol recycling process 1 begins with initial preparation 10. Initial preparation 10 includes the selection of the process parameters, including the cycle type, the flush type and the brick wash type. The cycle type includes, but is not limited to, the selection of paint, aerosol, or oil filters as media to be recycled. The flush type includes, but is not limited to, selecting the maximum, minimum, or none. The brick wash type is activated or not activated depending on the parameters selected. Initial preparation 10 includes monitoring that no alarms in the process are active and verifying the machine is in the home position.

The cycle begins 12 and the hopper is purged with nitrogen 14. The hopper oxygen levels are determined 16. If the oxygen level is not at a preferred level, the hopper is again purged with nitrogen 14. It is then determined if there are one or more aerosol can bricks in the receiver 20. If one or more bricks are in the receiver, the brick receiver is emptied 22. The receiver is then emptied 22 by unclamping and opening the receiver door, extending the kicker one or more times, and shutting and clamping the receiver closed.

If the oxygen level is at a preferred level 16 and there are no bricks in the receiver 20, the hopper is filled 24 with aerosol cans to be recycled. In a preferred embodiment, this step includes raising the skip hoist, unclamping the open hopper lid, dumping the skip hoist into the hopper, returning the skip hoist, and closing and clamping the hopper lid.

After the hopper is filled 24, compression 26 of the hopper begins. Compression 26 of the aerosol cans preferably utilizes a ram extending until a pressure spike results indicating compression, and held thus squeezing the aerosol containers for a brief period of time to allow the contents to drain, The brick size is calculated. If the brick is complete 28 the brick is moved into the receiver 32. The step of moving the brick into the receiver 32 is achieved by retracting the plug and extending the ram, extending and retracting the ram, and extending the plug and retracting the ram to the home position. If the brick is not complete 28, the ram is retracted 30 to allow loading of additional material. Compression 26 of the hopper begins. After the brick is moved into the receiver 32, it is then determined if the hopper is empty 34. If the hopper is not empty, compression 26 of the hopper begins again. If the hopper is empty, it is determined if liquid has been deposited in the sludge box 36. If there is no liquid in the sludge box 35, gas is removed from the CPU 44. If there is liquid in the sludge box 37, liquid is removed from the CPU 38. If the liquid is non-aerosols (paint, oil filters) the step of removing the liquid 40 includes opening the path to the sludge tank and starting the sludge pump. The sludge pump is then stopped when the low level sensor is cleared. The path to the sludge tank is closed and the hopper pressure is reduced to zero. If the liquid is aerosols, the process to remove the liquid aerosols from the CPU 42 includes opening a path to the vaporizer tank, allowing pressure difference to remove the liquid, and closing the path to the vaporizer tank when the low level sensor is cleared.

After liquid is removed from the sludge box 40, 42, gas is removed from the CPU 44. If the gas is from aerosols, then it is removed 48. Removing aerosol gas 48 includes opening a path to the vaporizer tank, allowing pressure difference to create an initial vacuum, closing the path to the vaporizer tank when pressure set point is reached, open a path to the vacuum pump, run the vacuum pump until the end of cycle vacuum set point is reached, stop the vacuum pump and hold vacuum to remove the gas from the CPU and zero the hopper pressure. If the gas is from non-aerosols (paint, oil filters) the vacuum sequence is not initiated 46. The cycle is then complete 50.

In a preferred embodiment, primarily two auto functions 60 are utilized, including maintaining a vacuum in the vaporizer tank 62 and relieving pressure in the buffer tank 70. In maintaining a vacuum in the vaporizer tank 62, vaporizer tank pressure must be monitored 64. If the pressure is greater than zero (0), then it is determined if the vacuum pump is available 66. If the vacuum pump is available, a vacuum is created in the vaporizer tank 68, including opening a path to the vacuum pump, running the vacuum pump until the pressure reaches the set point, and closing the path. The vacuum pump is then deactivated. If the vacuum pump is not available or the vaporizer tank is less than 0 PSI, then the process continues 67 until the vacuum pump is available 66 to create a vacuum in the vaporizer tank 68.

To relieve the pressure in the buffer tank 70, it must be determined if the buffer tank pressure is greater than 7 PSI 72. If the pressure is greater than 7 PSI 72, then it is determined if the gas compressor is available 74. If the gas compressor is available, then gas is removed from the buffer tank 76, which includes opening a path to the gas compressor and LPG tank, running the gas compressor until pressure reaches 0 PSI, and closing the path and turning off the gas compressor. If the gas compressor is not available 74, or the buffer tank is pressure is not at less than 7 PSI 72, the process continues 78 until the gas compressor is available.

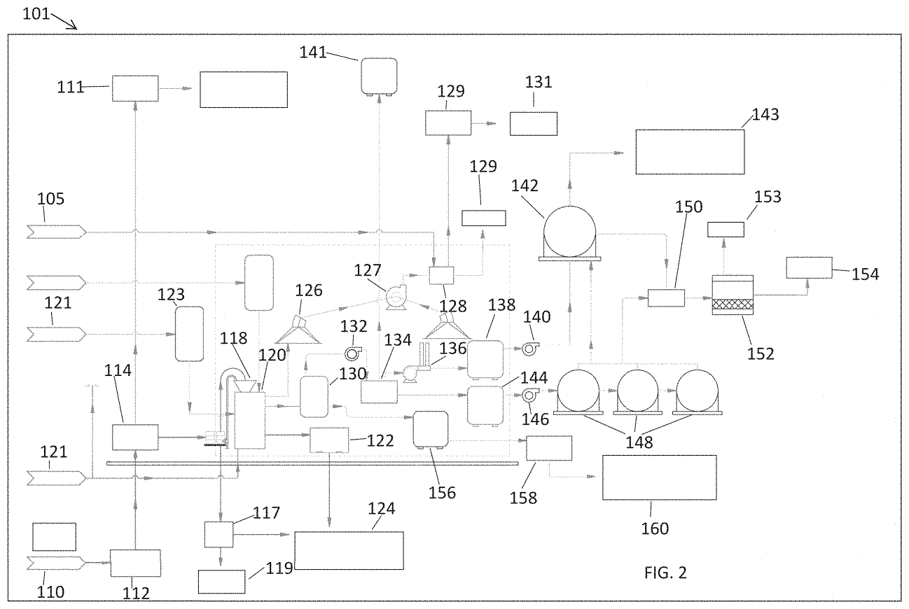

FIG. 2 illustrates a preferred embodiment of the aerosol recycling process 101. Aerosol cans are brought in sorted or unsorted 110 to the inbound staging area 112 and placed onto pallets. The cans can be manually sorted at the manual sorting table 114 and preferably placed in drums and the pallets are discarded for off-site incineration 111. The method preferably uses an aerosol crushing processing unit 120. The aerosol crushing processing unit is a mechanical device used to mechanically crush the cans to drain the contents as opposed to puncturing aerosol cans to drain the contents. The aerosol crushing processing unit has a crushing chamber for aerosol cans. The drums are unloaded into the hopper 118 where aerosol cans can be crushed in the aerosol crusher 120. The aerosol crusher 120 is powered by a power supply 121. The empty drums are discarded to the drum crusher 117 and subsequently utilized for metal recycling 124 or a landfill alternative 119. Compressed nitrogen 121 is stored in a nitrogen storage tank 123 and is used to purge the aerosol crusher 120 to create an inert atmosphere by use of a vacuum.

The aerosol crusher 120 releases the contents of the aerosol cans. The crushed aerosol cans are formed into a metal brick. Metal bricks are discarded to a satellite bin 122 where they typically are sent off for metal recycling 124.

In the aerosol crusher 120, waste gases are vented 126 and the liquid is sent to a separator tank 130. A vent 126 has a vent fan 127 with a carbon filter 128. Gases that pass through the carbon filter 128 are then vented to the atmosphere and the spent carbon filters are sent to storage 129 for off-site incineration 131.

Separator tank 130 houses captured gasses and liquids vacuum pumped 132 into a siloxane removal container 134. Propane from the siloxane removal container 134 is compressed and cooled 136 and stored in a propane control tank 138 and pumped 140 into a propane storage tank 142. Propane stored in the propane storage tank 142 is then prepared as offsite alternate fuel 143 or transferred to an liquid petroleum gas (LPG) air mixer 150. Any siloxane slurry remaining from the siloxane removal container 134 is transferred to a siloxane slurry container 141 where it is prepared for on-site treatment and disposal, either onsite or offsite.

The LPG mix from the siloxane removal container 134 is transferred to a LPG mix control tank 144. The LPG mix is then pumped 146 into LPG storage tanks 148. The LPG mix transferred to the propane storage tank 142 or directly to an LPG air mixer 150 and to a natural gas generator 152 where it is incinerated for energy with gas emissions vented 153 and electricity used via the isolation switchgear for aerosol operations electrical power 154.

Liquid sludge is removed from the separator tank 130 into the sludge container 156. The sludge in the sludge container 156 is transferred to a 90 day storage location 158 and taken off-site for fuel blending 160.

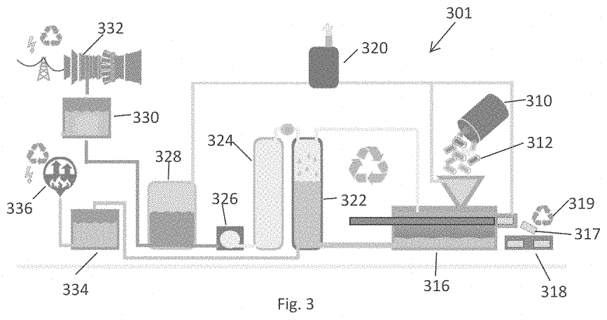

In a preferred embodiment of the aerosol recycling process 301 illustrated in FIG. 3, a sealable feed hopper 314 is configured to batch transfer aerosol cans 312 from a drum 310 into the aerosol crushing processing unit 316. Once the sealable feed hoper 314 is sealed, an inert atmosphere within the aerosol crushing processing unit 316 is created. This inert atmosphere begins prior to the commencing of the crushing/separation operation, and is maintained in the aerosol crushing processing unit during crushing cycles to eliminate the hazards associated with managing flammable liquids and gases.

In a preferred embodiment, a hydraulic or mechanical ram 315 in the crushing chamber of the aerosol crushing processing unit 316 moves across a screen floor of the crushing chamber as aerosol cans 312 are dropped into the chamber. The ram 315 presses out the contents of the aerosol cans and compacts the cans into rectangular bricks 317 that are preferably about 15 pounds in weight. When the bricks are sufficiently compacted, the discharge chamber 313 is preferably long enough that the bricks are dry to the touch when pushed into the metal brick collection hopper 318. The bricks are then recycled onsite or offsite 319.

As the ram 315 compacts the aerosol can into metal bricks and discharges the metal bricks into a collection hopper, the aerosol liquid and the propellant gasses are drawn into a separator tank 322 by a vacuum pump. The aerosol liquid is batch transferred by nitrogen pressurization of the separator tank to a satellite liquid accumulation tank 334.

A surge tank 324 is kept at approximately 5 PSIG pressure and will feed the “warm wet” propellant gas to a compressor 326 and heat exchanger system to liquefy and transfer the now liquefied gas to collection at an accumulation tank 328.

The vapor from the liquefied gas accumulation tank 328 is fed to a Hybrid Drying System 330 which will clean, dry, and condense the gas back into liquefied gas for supplying as LPG equivalent energy source.

Once the propellant gases have been compressed, cooled, and liquefied, the vapors from the accumulation tank will be fed to the Hybrid Drying System (HDS) 330. The HDS utilizes a wash tower to remove contaminants from the gas stream. The cleaned gas stream is then condensed into a liquefied gas stream by a refrigerated condensing system. The liquefied gas stream is dried and fine filtered by a molecular sieve tower and a pump transfers the clean dry liquid LPG equivalent gas to storage tanks for use as an energy source 332 for various operations, industries, and customers.

The water from the wash tower is purged and replenished throughout the batch cycle. The purged water is sent to a flash tank which is kept under a small vacuum (˜−5 PSIG) to vaporize, remove, and return any gas captured in the water back to the separator tank. The gas free water is transferred to a satellite liquid accumulation tank 334 for proper management 336.

The contents of the aerosol cans are then separated into additional tanks, where the contents are then further separated into LPGs and other gases, in order to be resold in virgin markets.

While certain exemplary embodiments are shown in the Figures and described in this disclosure, it is to be distinctly understood that the presently disclosed inventive concept(s) is not limited thereto but may be variously embodied to practice within the scope of this disclosure. From the foregoing description, it will be apparent that various changes may be made without departing from the spirit and scope of the disclosure as defined herein.

What is claimed is:

1. A process for recycling a plurality of aerosol cans, wherein said process comprises the following steps:
draining said plurality of aerosol cans under a vacuum;
collecting the materials discharged from said plurality of aerosol cans;
sorting the materials discharged from said plurality of aerosol cans; and
refining the materials discharged from said plurality of aerosol cans.

2. The process of claim 1 wherein said step of draining said plurality of aerosol cans comprises crushing said plurality of aerosol cans.

3. The process of claim 1, wherein the process further comprises the step of conditioning the sorted propellants for subsequent resale.

4. The process of claim 2 wherein the step draining said plurality of aerosol cans occurs in a aerosol crushing processing unit.

5. The process of claim 4 wherein the step of draining said plurality of aerosol cans is done in an inert atmosphere.

6. The process of claim 1 wherein said step of refining materials discharged from said plurality of aerosol cans is

7. A process for recycling a plurality of aerosol cans, said method comprising the steps of:
providing an aerosol crusher, said aerosol crusher comprising:
a chamber, wherein said chamber is configured for draining said plurality of aerosol cans;
a hopper, said hopper configured for inserting said plurality of aerosol cans into said chamber;
a ram configured to crush said plurality of aerosol cans;
wherein said aerosol crusher is configured for draining materials discharged from said plurality of aerosol cans and said aerosol crusher is configured for removing said aerosol cans;
crushing said plurality of aerosol cans in said aerosol crusher;
collecting materials discharged from said plurality of aerosol cans;
refining said materials discharged from said plurality of aerosol cans.

8. The process of claim 7, wherein the process further comprises the step of compacting said plurality of aerosol cans into a metal brick.

9. The process of claim 8 wherein said step of refining said material discharged from said plurality of aerosol cans further comprises the step of conditioning said materials discharged from said plurality of aerosol cans for subsequent resale.

10. The process of claim 7 wherein the step of crushing said plurality of aerosol cans in said aerosol crusher is performed in an inert atmosphere.

11. The process of claim 7 wherein the step of refining said materials discharged from said plurality of aerosol cans is performed by freezing and heating said materials discharged from said plurality of aerosol cans.

12. The process of claim 7 wherein the step of refining said materials discharged from said plurality of aerosol cans is performed by heating said materials discharged from said plurality of aerosol cans.

13. The process of claim 7 wherein the step of refining said materials discharged from said plurality of aerosol cans is performed by freezing said materials discharged from said plurality of aerosol cans.

14. The process of claim 7 wherein the step of crushing said aerosol cans take approximately 45 minutes.

15. A process for recycling a plurality of aerosol cans, said method comprising the steps of:
providing an aerosol crusher, said aerosol crusher comprising:
a chamber, wherein said chamber is configured for draining said plurality of aerosol cans;
a hopper, said hopper configured for inserting said plurality of aerosol cans into said chamber;
a ram configured to crush said plurality of aerosol cans into a metal brick;
wherein said aerosol crusher is configured for draining materials discharged from said plurality of aerosol cans and said aerosol crusher is configured for removing said aerosol cans;
crushing said plurality of aerosol cans in said aerosol crusher, wherein said step of crushing comprises the step of maintaining an inert atmosphere in said aerosol crusher;
collecting materials discharged from said plurality of aerosol cans;
refining said materials discharged from said plurality of aerosol cans for resale.
